(19) United States
(12) Patent Application Publication
(10) Pub. No.: US 2006/0273207 A1
(43) Pub. Date: Dec. 7, 2006

(54) Pressure chamber nozzle assembly

(76) Inventor: John R. Woods, Woodland Hills, CA (US)

Correspondence Address: PILLSBURY WINTHROP SHAW PITTMAN LLP, P.O BOX 10500, McLean, VA, 22102, US

(21) Appl. No.: 11/506,565

(22) Filed: Aug. 18, 2006

Related U.S. Application Data
(63) Continuation-in-part of application No. 10/831,913, filed on Apr. 26, 2004.

(51) Int. Cl. B05B 15/00

(52) U.S. Cl. 239/546; 239/337; 239/391

(57) ABSTRACT

A nozzle assembly is disclosed which provides for increased atomization, a finer spray, and a reduced tendency of the apparatus to clog. The nozzle assembly includes a pressure chamber through which the spray material must pass prior to exiting the spray container through a discharge orifice. As material exiting the container passes through the pressure chamber, pressure is built up, resulting in increased shearing and atomization of the spray material.

### CROSS-REFERENCE TO RELATED APPLICATIONS

This application is a continuation-in-part of pending U.S. patent application Ser. No. 10/831,913, filed Apr. 26, 2004.

### BACKGROUND OF THE INVENTION

1. Field of the Invention

This invention generally relates to a nozzle assembly for use with a spray can. More particularly, the invention relates to a nozzle assembly configured to induce additional pressure build-up so that the substance being sprayed is atomized to a higher degree, with a reduced incidence of clogging over other nozzles known in the art.

2. Description of Related Art

The practice of dispensing sprayable materials through traditional aerosol spray can valve assemblies has presented problems in that the nozzle on occasion may clog, particularly when the spray can is used infrequently. Additionally, in some instances, a greater degree of atomization may be desired for optimum functioning of the spray device. Furthermore, the practice of dispensing heavy and particulate materials through traditional aerosol spray can valve assemblies in the aerosol industry has presented problems in that the heavy and particulate materials to be dispersed have a tendency to clog up the valve assemblies. These heavy and particulate materials may include exterior stucco, heavy sand finishes, drywall and acoustic ceiling patching materials, fire suppressant materials, adhesive and bonding materials, and even culinary sauces.

As is well known in the art, traditional aerosol spray cans may be filled with material for dispensing. Similarly, a traditional aerosol spray can may be filled with heavy and particulate materials for spraying.

However, because of the placement of the valve assembly in traditional aerosol spray cans, both traditional spray materials as well as the heavy and particulate materials will clog up the valve assemblies and render the aerosol spray cans inoperative. For example, constant operation of these aerosol spray cans in spraying heavy and particulate materials is not possible due to the inconsistent ability of these traditional valve assemblies to dispense these materials without clogging.

U.S. Pat. No. 5,715,975, issued to Stern et al., discloses an aerosol spray texturing device that is comprised of a container, a nozzle, a valve assembly, and an outlet. The valve assembly in the '975 patent is located in the upper section of the container near the nozzle. Although the nozzle tube of the device in the '975 patent may be configured to spray texture materials, the device in the '975 patent still has the problem of clogging or packing of the valve assembly by the particulates contained in the texture material for spraying, especially if the particulates are large, like those found in stucco or other heavy and particulate materials mentioned above.

U.S. Pat. No. 5,645,198, also to Stern, discloses a number of different ways in which texture material may be dispensed from a spray can to achieve a variety of different textures. The general concept is that such different textures may be achieved by varying the diameter of the outlet orifice. Such variation in diameter of the outlet orifice may be achieved, for example, (a) by using a plurality of different straws, each having a different internal diameter, (b) through use of a rotatable cap having a plurality of differently sized holes for outlet orifices, (c) through use of a deformable straw with a constricting sleeves or (d) through use of a deformable outlet passageway with a deformable rotating cap. Such variety in textures which being available from one can is highly desirable in the eye of the consumer.

Therefore, a long-standing need has existed to provide an apparatus that may be used to readily apply spray materials, including heavy and particulate materials, in aerosol form with increased atomization and without clogging of the nozzle. In some instances, it may further be desirable to spray such materials in more than one texture. Furthermore, such spray should be contained in a hand-held applicator so that the materials may be conveniently stored, as well as dispensed in a simple and convenient manner without clogging or packing the valve assembly of the applicator.

### BRIEF SUMMARY OF THE INVENTION

The present invention provides a valve assembly for use in an aerosol spray can which is configured to spray material with an increased pressure, an increased degree of atomization and reduced clogging over traditional valve assemblies known in the art. Such improved functionality stems from the inclusion of a pressure chamber in the dispensing assembly prior to the discharge opening. The nozzle assembly is capable of spraying a wide variety of different types of materials. Such materials include, but are not limited to, paints, resins, other liquids and viscous materials or materials with large particulates.

The nozzle assembly according to the present invention uses many of the same elements as conventional nozzle assemblies, but incorporates a pressure chamber in the exit passageway so that material exiting the container passes through the pressure chamber prior to exiting the system through the discharge opening or orifice. The inclusion of the pressure chamber as part of the exit passageway allows for pressure build-up prior to the spray material's exit of the dispensing system and generates increased shearing and atomization. The increased pressure also leads to a reduced tendency for the nozzle to clog.

In embodiments, the nozzle assembly may comprise an actuator with a graduated tip extending therefrom. For example, the actuator is configured so that the opening from which the sprayable material enters the tip is larger than the opening from which the sprayable material exits the tip. A pressure chamber is fit over the graduated tip so that the chamber and the tip are in fluid communication with one another and the sprayable material flows from the graduated tip into the pressure chamber. The opening through which the sprayable material exits the tip and enters the pressure chamber is also larger than the opening from which the sprayable material exits the pressure chamber. In embodiments, the pressure chamber is comprised of rubber and has a generally cone-shaped structure. The pressure chamber may also be composed of other elastic or malleable materials in place of rubber. A dial component is further attached over the pressure chamber by screwing threads on the graduated tip that are complementary to screwing threads on the inside of the dial component. The dial component facilitates changing the diameter of the variable discharge opening so that different sprays may be dispensed. By altering the sprays, the user can apply the material to create surface textures of variable patterns onto the desired surface.

The nozzle assembly and pressure chamber of such embodiments may be used with any conventional aerosol container or aerosol system. For example, the nozzle assembly and pressure chamber may be used with a variety of spray devices like a spray gun hopper. As with conventional aerosol containers or systems, the actuator allows the user to selectively open or close the valve assembly so that the sprayable material is dispensed when desired.

In further embodiments, the nozzle assembly has two horizontally-aligned dials attached on the pressure chamber. As discussed above, each dial is attached to the nozzle assembly by screwing threads on the graduated tip. The user can tighten each one by turning the dial so that it screws toward the actuator and loosen each one by turning the dial so that it screws in the opposite direction—away from the actuator. One dial is used to alter how much material is allowed to enter the pressure chamber while the second dial is used to change the spray by altering the size of the variable discharge opening or orifice. The dials can operate independent of one another. This embodiment allows the user to change the pressure chamber if desired, change the variable discharge opening if desired, or change both if desired.

Embodiments of the invention subject the spray material to increased pressure prior to dispensing. The present embodiments of the pressure chamber facilitates greater compression of the sprayable material prior to exiting than previously known nozzle assemblies. This higher level of compression causes better shearing of the material so that the material is sprayed with much higher atomization. The increased pressure also leads to a reduced tendency for the nozzle to clog.

### BRIEF DESCRIPTION OF THE DRAWINGS

FIG. 1 is a front view of a pressure chamber valve assembly in accordance with one embodiment of the present invention;

FIG. 2 is a cross-sectional view of a pressure chamber valve assembly in accordance with the embodiment of the present invention shown in FIG. 1, taken along the “A-A” line of FIG. 1;

FIG. 3 is a side view of a pressure chamber valve assembly in accordance with one embodiment of the present invention;

FIG. 4 is a perspective view of a spray device which incorporates the pressure chamber valve assembly in accordance with one embodiment of the present invention;

FIG. 5 is a cross-sectional view of a pressure chamber valve assembly in accordance with one embodiment of the present invention;

FIG. 6 is a cross-sectional view of a pressure chamber valve assembly in accordance with one embodiment of the present invention;

FIG. 7 is a cross-sectional view of a pressure chamber valve assembly in accordance with one embodiment of the present invention;

FIG. 8 is an exploded view of a pressure chamber valve assembly in accordance with one embodiment of the present invention;

FIG. 9 is a cross-sectional view of the pressure chamber valve assembly of FIG. 5;

FIG. 10 is an external side view of a pressure chamber valve assembly in accordance with one embodiment of the present invention; and

FIG. 11 is an alternative side view of a pressure chamber valve assembly in accordance with one embodiment of the present invention.

### DETAILED DESCRIPTION

The present invention provides a valve assembly for use in an aerosol spray can which is configured to spray material with an increased pressure, an increased degree of atomization and reduced clogging over traditional valve assemblies known in the art. Such improved functionality stems from the inclusion of a pressure chamber in the dispensing assembly prior to the discharge opening. The nozzle assembly is capable of spraying a wide variety of different types of materials. Such materials include, but are not limited to, paints, resins, other liquids and viscous materials or materials with large particulates. The present invention may also be used in a wide variety of spray devices, including but not limited to, spray guns, spray hoppers, aerosol cans and canisters, and the like.

The present invention provides an inexpensive and economical means for dispensing materials with an increased degree of atomization and a reduced incidence of clogging of the nozzle. Such reduced clogging is believed to be facilitated by the increased spray pressure and resulting atomization of the material which is being sprayed. Not only is the present invention easy to manufacture and assemble, but the reduced incidence of clogging results in increased user satisfaction and is expected to lead to a lower incidence of returns due to clogged nozzles.

When the present invention is used in association with known texture-modifying structures, it also provides an inexpensive and economical means for matching surface texture of a repaired or patched texture surface area. Since the spray-on hardenable texture material covers the repaired or patched area and visually assumes the surface texture of the surrounding patched or repaired surface, this results in the user seeing an improvement in the appearance of patched or repaired areas on a textured surface.

Aerosol assemblies are well known in the art. Generally, they comprise a container, a valve assembly, and an actuator member. As is also well known in the art, depressing the actuator member moves the valve assembly into its open position in which an exit passageway is defined from the interior of the container to the exterior of the container. When in the open position, the pressure chamber, dip tube and discharge opening are configured to be in flowable communication so that sprayable material in the container can be dispensed. The exit passageway generally terminates in a discharge opening formed in the actuator member.

The nozzle assembly according to the present invention uses many of the same elements as prior art nozzle assemblies, but additionally includes a pressure chamber in the exit passageway so that material exiting the container passes through the pressure chamber prior to exiting the system through the discharge orifice or opening. The inclusion of the pressure chamber as part of the exit passageway allows for pressure build-up prior to the spray material's exit of the dispensing system.

The invention subjects the spray material to increased pressure prior to dispensing. This assists in shearing the material and provides increased atomization of the spray material. The increased pressure also leads to a reduced tendency for the nozzle to clog. Preventing clogging is important, especially for acoustic materials used for creating irregular surface textures. These materials are useful for repairing and matching existing surfaces, such as for example, stucco walls. Acoustic materials can cause clogging due to the particulates that they contain in order to form a layer having the irregular surface texture. For example, acoustic materials generally contain particulate filler materials, such as for example, calcium carbonate, silica, talc, wollastonite, and the like. The particulate filler material desirably has various particle sizes and shapes so that when the acoustic material is applied onto the desired surface, the particulate forms irregular surface textures.

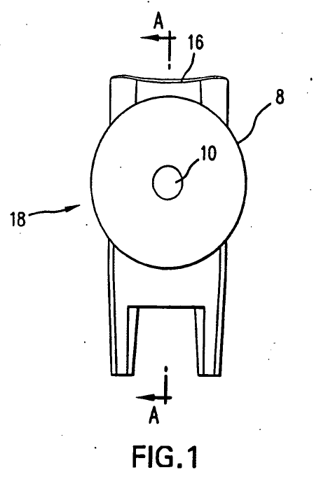

FIG. 1 is a front view of a valve assembly 18 in accordance with one embodiment of the present invention. This figure shows the variable nozzle 8 having a variable discharge opening 10 which is aligned with the pressure chamber 14 (not shown) discharge opening or exit orifice, and the actuator 16. In some embodiments, the variable nozzle 8 is coupled to the valve assembly by screwing threads. The user may tighten or loosen the variable nozzle 8 to enlarge or reduce the size of the variable discharge opening 10. That is, when the variable nozzle 8 is tightened, the rubber is pushed back and the variable discharge opening 10 is able to discharge more spray texture material, with less fine particles. In contrast, when the variable nozzle 8 is loosened, the rubber is relaxed, and the variable discharge opening 10 discharges less spray material, with finer particles. Thus, a smaller diameter variable discharge opening 10 results in a finer spray texture, while a larger diameter variable discharge opening results in a courser spray texture.

The variable nozzle 8 is one of many features of the present embodiments which may be added to permit the user to vary the resulting texture of the spray material being dispensed. Furthermore, such texture-varying means are not required to use the valve assembly according to the present embodiments.

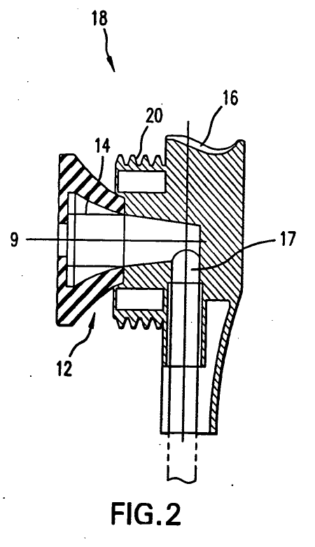

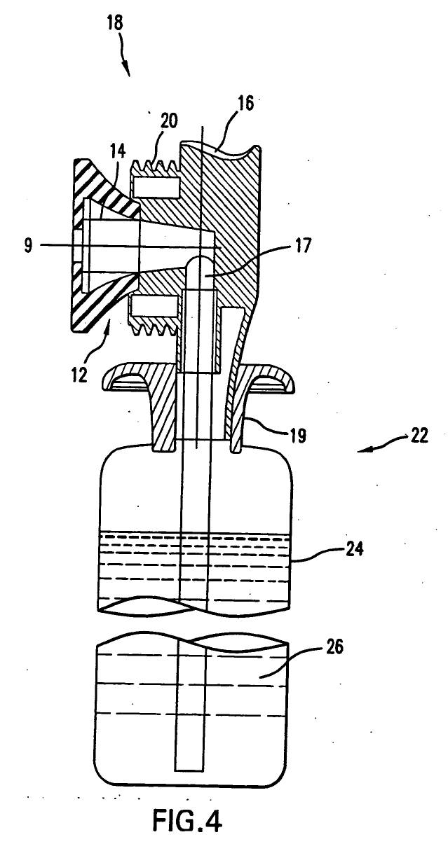

FIG. 2 is a cross-sectional view of a valve assembly 18 in accordance with the embodiment of the present invention shown in FIG. 1, taken along the “A-A” line of FIG. 1. As shown, this figure does not include a variable spray nozzle. The pressure chamber 14 is generally flared, with the flare starting back where the pressure chamber 14 is coupled to the vertical portion 17 of the discharge passageway. The vertical portion 17 of the discharge passageway comprises, at a minimum, a dip tube. The dip tube may be of sufficient length so as to extend into container 24 (See FIG. 4) and only along a portion of its height. Alternatively, the dip tube may extend to the bottom of the container 24.

As used herein, the term “discharge passageway” will refer to that structure or those structures through which the spray material passes en route from the holding container (not shown), through the pressure chamber discharge opening 9, to the variable discharge opening 10.

In different embodiments, the pressure chamber may take a variety of different shapes. By way of example, and not of limitation, it may be cone-shaped or flare at a greater or lesser angle, it may be bulbous or it may be square or rectangular. Alternatively, the diameter of the discharge passageway may remain the same after it assumes a generally horizontal configuration, and may widen into the pressure chamber at some point subsequent to its turn to the horizontal configuration (that is, from a generally vertical to generally a horizontal configuration).

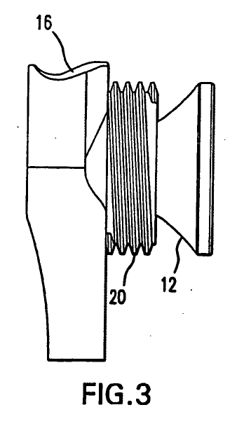

FIG. 3 is a side view of a valve assembly 18 in accordance with one embodiment of the present invention. This figure shows the exterior 12 of the pressure chamber 14, the actuator 16, and threads 20. As will be realized by one of ordinary skill in the art, such threads are simply one means through which a protective cap may be coupled to the present invention.

The valve assembly 18 is preferably generally formed from plastics using means readily known in the art. However, other materials may also be used to form the valve assembly 18, or portions thereof, including, but not limited to, resins or metals. Of course, if the valve assembly 18 is used in association with a variable nozzle 8, the variable discharge opening 10 will preferably be formed from rubber or other readily malleable material.

FIG. 4 is a perspective view of a spray device 22 which incorporates the pressure chamber valve assembly 18 in accordance with one embodiment of the present invention. As may be seen, the spray device 22 generally includes a valve assembly 18, a bushing 19, a container 24 and spray material 26.

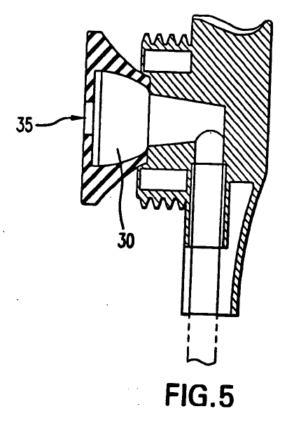

FIG. 5 is a cross-sectional view of another embodiment of the present invention. As may be seen, the pressure chamber 30 depicted is generally bulbous in shape. Adjacent to the pressure chamber 30 is a discharge opening 35 that is adapted to be in flowable communication with the pressure chamber 30. The discharge opening 35 has a diameter that is smaller than a diameter of the portion of the pressure chamber that abuts the discharge opening.

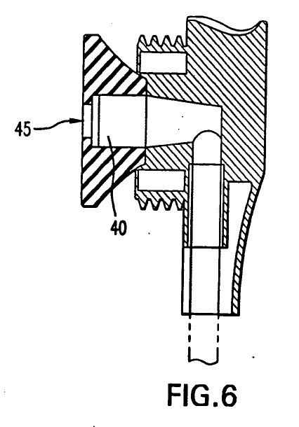

FIG. 6 is a cross-sectional view of another embodiment of the present invention. As may be seen, the pressure chamber 40 depicted is generally square in shape. Adjacent to the pressure chamber 40 is a discharge opening 45 that is adapted to be in flowable communication with the pressure chamber 40. The discharge opening 45 has a diameter that is smaller than a diameter of the portion of the pressure chamber that abuts the discharge opening.

FIG. 7 is a cross-sectional view of another embodiment of the present invention. As may be seen, the pressure chamber 50 depicted is generally rectangular in shape. Adjacent to the pressure chamber 50 is a discharge opening 55 that is adapted to be in flowable communication with the pressure chamber 50. The discharge opening 55 has a diameter that is smaller than a diameter of the portion of the pressure chamber that abuts the discharge opening.

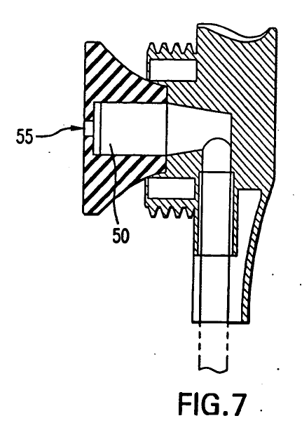

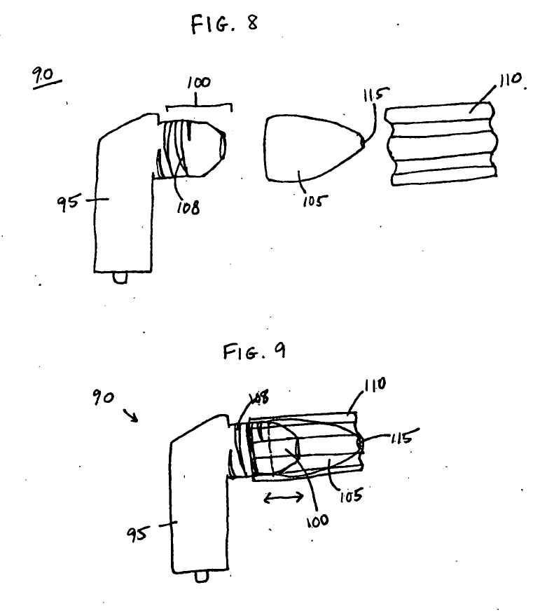

In further embodiments, shown in FIGS. 8 and 9, the nozzle assembly 90 may comprise an actuator 95 with a graduated tip 100 extending therefrom. A pressure chamber 105 is fit over the graduated tip 100 so that the chamber and the tip are in fluid communication with each other and the sprayable material flows from the graduated tip 100 into the pressure chamber 105. In such embodiments, the actuator 95 is configured so that the opening from which the sprayable material enters the tip 100 is larger than the opening from which the sprayable material exits the tip 100. The opening through which the sprayable material exits the tip 100 and enters the pressure chamber 105 is also larger than the opening from which the sprayable material exits the pressure chamber 105. In embodiments, the pressure chamber 105 is comprised of rubber and has a generally cone-shaped structure. The pressure chamber 105 may also be composed of other elastic or malleable materials in place of rubber. A dial component 110 is further attached over the pressure chamber 105 by screwing threads 108 on the graduated tip 100 that are complementary to screwing threads on the inside of the dial component 110. The dial component 110 facilitates changing the diameter of the variable discharge opening 115 so that different sprays may be dispensed. By altering the sprays, the user can apply the material to create surface textures of variable patterns onto the desired surface.

The nozzle assembly and pressure chamber of such embodiments may be used with any conventional aerosol container or aerosol system. As with conventional aerosol containers or systems, the actuator allows the user to selectively open or close the valve assembly so that the sprayable material is dispensed when desired.

The force with which the sprayable material is transferred from the container and through the nozzle assembly 90 is multiplied by the pressure chamber 105. The sprayable material is propelled from the container into the graduated tip 100. The sprayable material is sequentially propelled from the graduated tip 100 into the pressure chamber 105 from which it is ultimately dispensed onto the desired surface. The shape of the pressure chamber 105 and the multiplied force help compress a much greater amount of material together prior to exiting than previously known nozzle assemblies. The high compression causes better shearing of the material so that the material is sprayed with much higher atomization.

The graduated tip 100 begins building pressure before the material enters the pressure chamber 105. For example, pressure builds up as material enters the graduated tip 100 because the gradual decrease in diameter quickly compresses the material together as the material exits the graduated tip 100 and enter into the pressure chamber 105. The compressed sprayable material is further compressed within the pressure chamber 105. Thus, even more pressure is built up in the pressure chamber 105, adding to the amplified compression and further shearing of the material and further shearing.

The dial component 110 facilitates the changing of the diameter of the variable discharge opening 115 so that different sprays may be dispensed. By altering the sprays, the user can apply the material to create surface textures of variable patterns onto the desired surface. The pressure chamber 105 comprises an elastic material which is deformable in a manner to vary the size of the spray opening 55. The dial component 50 contacts the variable discharge opening 115 of the pressure chamber 105 uniformly in a circumferential direction around the opening. The dial component 110 is movable relative to the pressure chamber 105 and graduated tip 100 to apply a deforming force in a direction parallel to the direction in which the sprayable material is dispensed from the variable discharge opening 115 for deforming the elastic material of the pressure chamber 105 to vary the size of the spray opening.

The user may tighten or loosen the dial component 110 to enlarge or reduce the size of the variable discharge opening 115. In these embodiments, the variable discharge opening 115 is where the sprayable material exits from the pressure chamber 105. That is, when the dial 110 is tightened, the rubber surrounding the circumference of the variable discharge opening 115 of the pressure chamber 105 is pushed back and the variable discharge opening 115 is enlarged. In this manner, the nozzle assembly 90 is able to discharge more spray texture material, with less fine particles. In contrast, when the dial 110 is loosened, the rubber is relaxed, and the variable discharge opening 115 is reduced in size to discharge less spray material, with finer particles. Thus, a smaller diameter variable discharge opening 115 results in a finer spray texture, while a larger diameter variable discharge opening 115 results in a courser spray texture.

The dial 110 is attached to the base of the graduated tip 100 by screwing threads 108. The user can tighten the dial 110 by turning the dial on the threads 108 in one direction while the user can loosen the dial 110 by turning the dial 110 on the threads 108 in the opposite direction. More specifically, when the variable discharge opening 115 is tightened by screwing the dial 110 in towards the actuator 95, the rubber surrounding the variable discharge opening 115 is pushed or flexed back and the variable discharge opening 115 is stretched wider. When the dial 110 is loosened by screwing the dial 110 away from the actuator 95, the rubber surrounding the discharge opening 115 is relaxed. The dial component 110 may also be removed completely if so desired.

Embodiments of the invention subject the spray material to increased pressure prior to dispensing. The present embodiments of the pressure chamber facilitates more compression of the sprayable material than previously known nozzle assemblies. This higher level of compression causes better shearing of the material so that the material is sprayed with much higher atomization. The increased pressure also leads to a reduced tendency for the nozzle to clog.

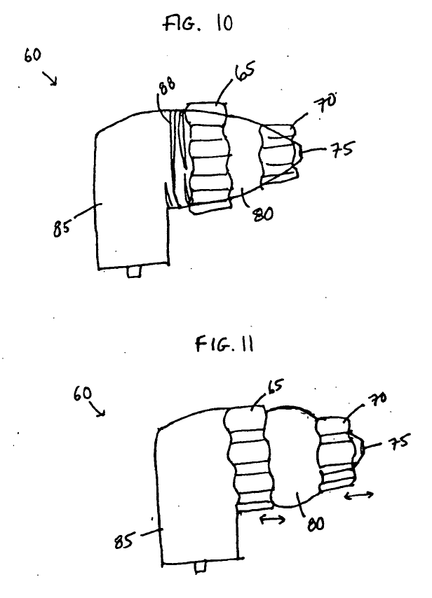

In another embodiment, shown in FIGS. 10 and 11, the nozzle assembly has two horizontally-aligned dial components 65, 70 attached to the pressure chamber 80. As discussed above, each dial is attached to the nozzle assembly 60 by screwing threads 88. The user can tighten the dials 65, 70 by turning each dial so that it screws toward the actuator 85 and loosen each one by turning the dial so that it screws in the opposite direction-away from the actuator 85. One dial 65 is used to alter how much material is allowed to enter the pressure chamber 80 while the other dial 70 is used to alter the diameter of the variable discharge opening 75 of the pressure chamber 80. The dials 65, 70 can operate independent of one another.

In these embodiments, the nozzle assembly 60 has a first dial 65 and a second dial 70 aligned horizontally. The first dial 65 is used to control how much material is released from the container into the pressure chamber 80. The first dial 65 can constrict the pressure chamber 80 so that less material enters the chamber 80 and thus less pressure is built up. The first dial 65 may also relax the entry into the pressure chamber 80 from the container so that more material is compressed into the pressure chamber 80 and high pressure is built up. Thus, the first dial 65 allows the user to select the amount of shearing and subsequent atomization desired. The second dial 70 is used to vary the variable discharge opening 75 so as to change the dispensed spray, as described above. The second dial 70 allows the user to select the type of spray to be dispensed, e.g., coarse or fine spray. In these embodiments, the variable discharge opening 75 is where the sprayable material exits from the pressure chamber 80. Embodiments shown in FIGS. 10 and 11 allow the user to change the pressure chamber 80 if desired, change the variable discharge opening 75 if desired, or change both if desired. For example, the user may loosen the first dial 65 so as to allow more material to enter the pressure chamber 80 resulting in greater shearing and atomization. If the user wants to create a finely atomized spray, the user may additionally loosen the second dial 70 so that the variable discharge opening 75 is smaller. The user may also tighten the first dial 65 so less material enters the pressure chamber 80 if less shearing is desired, and tighten the second dial 70 to achieve a coarse spray. Of course, the user may also tighten the first dial 65 while loosening the second dial 70 or vice versa, depending on the level of shearing/atomization and type of spray desired. In this manner, the user may customize how the sprayable material is dispensed in a variety of combinations.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A nozzle assembly for dispensing a sprayable material, the assembly comprising:
an actuator coupled to the top opening of the dip tube, the actuator having a graduated tip extending therefrom;
a pressure chamber attached to the graduated tip, the pressure chamber being adapted to be in flowable communication with the graduated tip and the dip tube;
a variable discharge opening in flowable communication with the pressure chamber, the variable discharge opening having a diameter that is smaller than a diameter of the pressure chamber; and
a dial component attached over the pressure chamber by screw threads on the graduated tip, wherein the dial component contacts the variable discharge opening uniformly in a circumferential direction around the variable discharge opening and is movable relative to the pressure chamber and the graduated tip to apply a deforming force in a direction parallel to the direction in which the sprayable material is dispensed from the variable discharge opening to vary the size of the variable discharge opening.

2. The nozzle assembly of claim 1, wherein the pressure chamber is generally cone-shaped.

3. The nozzle assembly of claim 1, wherein the graduated tip has a diameter that gradually decreases as the graduated tip extends away from the actuator.

4. The nozzle assembly of claim 1, wherein the pressure chamber is rubber.

5. The nozzle assembly of claim 1, wherein the size of the variable discharge opening is changed by a user.

6. The nozzle assembly of claim 5, wherein the user can vary the surface texture formed by the dispensed sprayable material by changing the size of the variable discharge opening.

7. The nozzle assembly of claim 1 being adapted to apply the sprayable material so that a layer having an irregular surface texture is formed.

8. A nozzle assembly for dispensing a sprayable material, the assembly comprising:
an actuator coupled to the top opening of the dip tube;
a pressure chamber adapted to be in flowable communication with the dip tube;
a variable discharge opening in flowable communication with the pressure chamber, the variable discharge opening having a diameter that is smaller than a diameter of the pressure chamber;
a first dial component attached over the pressure chamber, wherein the first dial component contacts the pressure chamber uniformly in a circumferential direction around the exterior of the pressure chamber and is movable relative to the pressure chamber to apply a deforming force in a direction parallel to the direction in which the sprayable material is dispensed from the variable discharge opening to vary an amount of sprayable material that is allowed into the pressure chamber; and
a second dial component attached over the pressure chamber, wherein the second dial component contacts the variable discharge opening uniformly in a circumferential direction around the variable discharge opening and is movable relative to the pressure chamber to apply a deforming force in a direction parallel to the direction in which the sprayable material is dispensed from the variable discharge opening to vary the size of the variable discharge opening.

9. The nozzle assembly of claim 8, wherein the pressure chamber is generally cone-shaped.

10. The nozzle assembly of claim 8, wherein the pressure chamber is rubber.

11. The nozzle assembly of claim 8, wherein the size of the variable discharge opening is changed by a user.

12. The nozzle assembly of claim 11, wherein the user can vary the surface texture formed by the dispensed sprayable material by changing the size of the variable discharge opening.

13. The nozzle assembly of claim 8, wherein the amount of sprayable material that is allowed into the pressure chamber is changed by a user.

14. The nozzle assembly of claim 13, wherein the user can vary shearing level of the sprayable material by changing the amount of sprayable material that is allowed into the pressure chamber.

15. The nozzle assembly of claim 8 being adapted to apply the sprayable material so that a layer having an irregular surface texture is formed.

16. The nozzle assembly of claim 8, wherein the first dial and the second dial move independent of each other.

17. An aerosol system comprising:
a container;
a sprayable material in the container;
a nozzle assembly that sprays the sprayable material from the container; and
a dip tube having a top opening and a bottom opening, wherein the dip tube is attached to the nozzle assembly and is at least primarily disposed inside the container, and wherein the nozzle assembly comprises
an actuator coupled to the top opening of the dip tube, the actuator having a graduated tip extending therefrom,
a pressure chamber attached to the graduated tip, the pressure chamber being adapted to be in flowable communication with the graduated tip and the dip tube,
a variable discharge opening in flowable communication with the pressure chamber, the variable discharge opening having a diameter that is smaller than a diameter of the pressure chamber, and
a dial component attached over the pressure chamber by screw threads on the graduated tip, wherein the dial component contacts the variable discharge opening uniformly in a circumferential direction around the variable discharge opening and is movable relative to the pressure chamber and the graduated tip to apply a deforming force in a direction parallel to the direction in which the sprayable material is dispensed from the variable discharge opening to vary the size of the variable discharge opening.

18. The aerosol system of claim 16, wherein the graduated tip has a diameter that gradually decreases as the graduated tip extends away from the actuator.

19. An aerosol system comprising:
a container;
a sprayable material in the container;
a nozzle assembly that sprays the sprayable material from the container; and
a dip tube having a top opening and a bottom opening, wherein the dip tube is attached to the nozzle assembly and is at least primarily disposed inside the container, and wherein the nozzle assembly comprises
an actuator coupled to the top opening of the dip tube,
a pressure chamber adapted to be in flowable communication with the dip tube,
a variable discharge opening in flowable communication with the pressure chamber, the variable discharge opening having a diameter that is smaller than a diameter of the pressure chamber,
a first dial component attached over the pressure chamber, wherein the first dial component contacts the pressure chamber uniformly in a circumferential direction around the exterior of the pressure chamber and is movable relative to the pressure chamber to apply a deforming force in a direction parallel to the direction in which the sprayable material is dispensed from the variable discharge opening to vary an amount of sprayable material that is allowed into the pressure chamber, and
a second dial component attached over the pressure chamber, wherein the second dial component contacts the variable discharge opening uniformly in a circumferential direction around the variable discharge opening and is movable relative to the pressure chamber to apply a deforming force in a direction parallel to the direction in which the sprayable material is dispensed from the variable discharge opening to vary the size of the variable discharge opening.

20. The aerosol system of claim 18, wherein the size of the variable discharge opening is changed by a user.

21. The aerosol system of claim 18, wherein the amount of sprayable material that is allowed into the pressure chamber is changed by a user.
